(19) United States
(12) Patent Application Publication
(10) Pub. No.: US 2026/0083541 A1
(43) Pub. Date: Mar. 26, 2026

(54) NURSING APPARATUS AND TECHNIQUE FOR ORPHANED ANIMALS

(71) Applicant: Darlene L. Smith, Eaton Rapids, MI (US)

(72) Inventor: Darlene L. Smith, Eaton Rapids, MI (US)

(21) Appl. No.: 18/891,616

(22) Filed: Sep. 20, 2024

(51) Int. Cl. A61D 7/04

(52) U.S. Cl. CPC A61D 7/04; A01K 9/005

(57) ABSTRACT

A nursing apparatus and related technique as presented for nursing orphaned baby animals. The invention consists of a feeding syringe adapted for receiving a nipple cap having an elongated nipple of elliptical or flat-like cross-section. The elongated nipple has an inlet bore in communication with the feeding syringe and an outlet bore interposed between and in communication with the inlet bore and a nipple opening. The nipple cap is slip or friction fit onto the feeding syringe. The inlet bore is of a larger diameter than the outlet bore to establish a land area there between. Pressure of fluid from the syringe impacts the land area, generating a force. Before that force becomes sufficient to aspirate the baby animal being fed, the force causes the nipple cap to separate from the feeding syringe, preventing such aspiration. The nipple caps are sized and color coded to accommodate selection consistent with the age/physical size of the baby as it matures.

### TECHNICAL FIELD

The invention herein resides in the art of feeding apparatus and techniques and, more particularly, to such apparatus and techniques for nursing orphaned baby animals. Specifically, the invention relates to molded nipples received by a hypodermic syringe for generating a flow of liquid nourishment through a nipple that replicates that of the mother animal, thus achieving significant efficacy while minimizing risks of aspiration, choking and the like. Within the confines of available materials and techniques, the invention sufficiently replicates the mother's teat to accommodate adaptation of the baby to the device with minimal risk of aspiration, choking or the like.

### BACKGROUND OF THE INVENTION

It is not at all unusual for a nursing mother animal to encounter early death from predators such as wolves, foxes, birds of prey and domestic animals such as dogs and cats, leaving behind orphaned babies in need of immediate care to avoid suffering and early death, as well. Of primary importance in treating orphaned babies is to provide them with nourishment sufficient to maintain their health and to support their growth, and to make the delivery of that nourishment as similar to that of nature that the orphaned baby quickly accepts the new source, with the new source having minimal attendant risks to the baby.

While a broad range of animals may benefit from the concept and structure of the present invention, the invention presently addresses the needs of cottontail rabbits, squirrels, opossums, and fawns. The presence of orphaned babies of these species of animals is legion.

In the past, a bottle intended for the feeding of baby human beings or the like has been used to attempt to nurse orphaned baby animals. While the prior art may have accommodated a bottle structure of a size smaller than that used for a human baby, those nursing bottles, both in structure and in function, have typically been of a rather rudimentary and generic nature. Typically, there has been no pre-made hole in the end of the nipple and the nipple has provided no flow regulation for the milk being offered to the baby. Moreover, known devices are simply too big for use by orphaned baby animals, many of which are orphaned before their eyes are open, their bodies are covered with hair, or they only have their most basic of instincts. Previously known nipples have been of a hollow rubber construction, with a cavity that often results in a gush or surge of milk when offered to the baby, giving way to aspiration and resulting in choking, pneumonia, or other maladies.

In the prior art, nursing nipples for infant animals have generally been of a one size fits all nature. As a result, the diameter of the nipple is typically too large, the length of the nipple is too long and the material from which the material is made is too hard to afford many orphaned infant animals a chance at survival. None of these structures are motivated by any attempt to replicate the mother's nipple.

In general, the prior art has taught the implementation of cold hard natural rubber for the manufacture of nursing nipples. However, such have demonstrated a poor resistance to hydrocarbons, fats, oils, or greases. Accordingly, contact with such substances can cause swelling of the rubber, softening and deforming of the rubber and/or a dissolution of the rubber part resulting in partial or complete failure.

There is a need in the art for a nursing apparatus and technique for orphaned animals for which purity and safety are paramount, which are made of a food-grade silicone, with food-grade coloring to minimize any risk to the baby animals.

More particularly, there is a need in the art for nursing apparatus and techniques for orphaned baby animals that significantly replicates the nipples or teats of the mother, which are typically flat and tapered. Moreover, it is desirable that such nursing apparatus be resistant to damage and degradation from varying temperatures, resistant to hardening, cracking, peeling, crumbling, drying out, rotting, or becoming brittle over time, while being resistant to heat, fungus and chemicals.

It is particularly desirable that the nipple be food-grade and odorless and contain no BPA, latex, lead or phthalates.

Unlike the prior art, it is desired that the nipples do not smell like rubber but exhibit a high level of toughness and elasticity, not subjected to permanent deformation from the action of external forces.

It is most desirable that since the orphaned infant animal must be cared for until reaching a size and maturity to care for itself, various sizes of the nipple for each species needs to be provided to accommodate growth of the babies as in nature.

Further replication is desired by adapting a flow chamber within the nipple just as the mother animal's nipple has. A flow chamber is required and provided to reduce aspiration. Moreover, the nipple is desired to be textured so that the suckling baby can latch onto the nipple without slipping off. It is further desired that a pop-off pressure valve be provided to regulate and restrict pressure buildup within the flow chamber, reducing or substantially eliminating any likelihood that a blowoff of pressure may occur.

Finally, it is desirable that the nipple be of a semi-transparent nature, allowing the user to actually see the milk flow while the animal is being fed.

### DISCLOSURE OF INVENTION

The foregoing and various aspects of the invention that will become apparent herein are achieved by a nursing device for baby animals, comprising: a feeding syringe; and a nipple cap adapted for receipt by said syringe, said nipple cap having an elongated nipple of elliptical cross section, said elongated nipple having an inlet bore in communication with said feeding syringe and an outlet bore interposed between and in communication with said inlet bore and a nipple opening.

Other aspects of the invention that will become apparent herein are achieved by a nursing device for baby animals, comprising: a feeding syringe; and a nipple cap adapted for receipt by said syringe, said nipple cap having an elongated nipple of elliptical cross section, said elongated nipple having an inlet bore in communication with said feeding syringe and an outlet bore interposed between and in communication with said inlet bore and a nipple opening, said nipple cap having an enlarged body integral with said nipple, said body and nipple formed of a silicone elastomer.

### DESCRIPTION OF DRAWINGS

For a complete understanding of the various structures, techniques and aspects of the invention, reference should be made to the following detailed description and accompanied drawings, wherein:

FIG. 1 is a perspective view of a feeding syringe for orphaned baby animals made in accordance with the invention;

FIGS. 2A, 2B, 2C and 2D are front elevational, side elevational, top plan and bottom plan views of a nipple cap configured for feeding orphaned baby cottontail rabbits and squirrels;

FIGS. 3A, 3B, 3C, and 3D are front elevational, side elevational, top plan and bottom plan views of a nipple cap for implementation with the feeding syringe of FIG. 1 for use with deer fawns;

FIGS. 4A, 4B, 4C and 4D are front elevational, side elevational, top plan and bottom plan views of a nipple cap assembly for implementation with the embodiment of FIG. 1 for use in their sink baby opposums; and

FIG. 5 is a chart of specific dimension of the preferred embodiments presented and described herein.

### DETAILED DESCRIPTION OF PREFERRED EMBODIMENTS

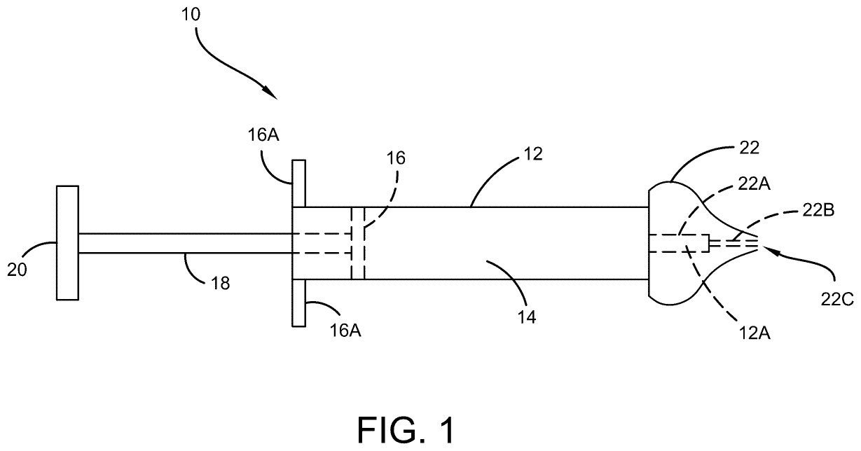

Referring now to the drawings, and more particularly FIG. 1, a feeding syringe assembly, according to the general concepts of the invention, is designated generally by the numeral 10. The feeding syringe assembly 10 comprises a cylinder 12 having a cylinder extension 12A extending from a first end thereof. The cylinder 12 defines a cavity 14 in communication with a hollow passage of the cylinder extension 12A to allow communication therebetween. A piston head 16 is received within the cavity 14, the piston head 16 being adapted to be driven by a piston rod 18 having a drive thumb pad 20 at an end of the piston rod 18 opposite that of the head 16. Finger grips 16A extend from diametrically opposed edges of the cylinder 12. In standard fashion, the user typically places an index and middle finger in engagement with the finger grips 16A, and exerts pressure against the thumb pad 20 to push the piston head 16 forward in the cavity 14 to force fluid from the cavity.

With continued reference to FIG. 1, a nipple cap 22 has a first larger diameter bore 22A, adapted for receiving the cylinder extension 12A by a slip or friction fit. A smaller diameter bore 22B extends coaxially from the larger diameter bore 22A to exit the nipple cap 22 through the opening 22C.

The nipple cap 22 is preferably of an elastomeric material to effect the desired friction fit between the hollow cylinder extension 12A and the bore 22A. As will be presented later herein, the friction fit and the difference of the diameter of the bores 22A and 22B effect a relief valve of sorts to prevent over pressurization of the fluid within the cavity 14 which could possibly result in excess fluid being forced out of the nipple opening 22C and risking aspiration of the baby animal being fed.

It will be appreciated that the nipple cap 22 will be of various configurations and sizing to accommodate the babies of various species of animals. Several of those are presented in the following drawings as discussed below.

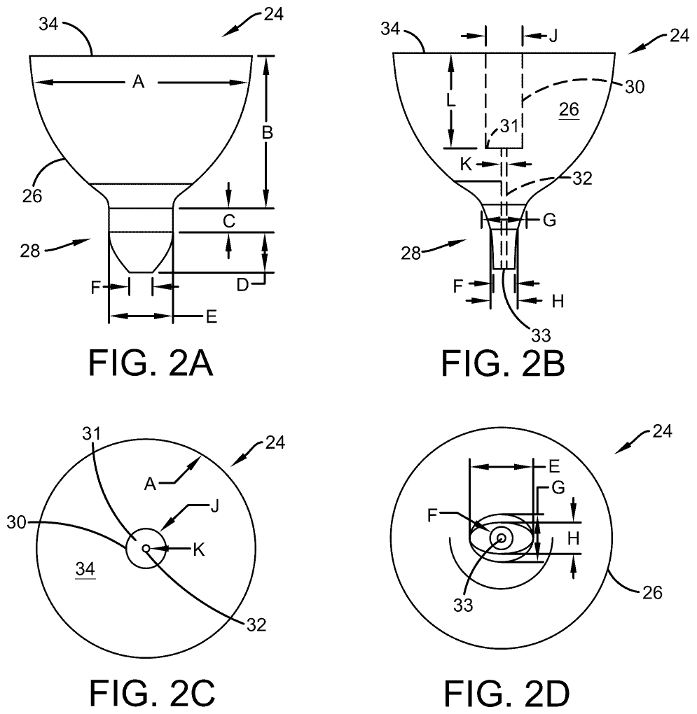

With reference to FIGS. 2A-2D, there is presented a nipple cap 24 particularly adapted for use in nursing cottontail bunnies and squirrel babies. The nipple cap 24 is characterized by a mound-shaped body 26 having a nipple 28 extending therefrom. As apparent from the illustration of FIGS. 2A-2D, the nipple 28 tapers from a round to a substantially elliptical shape, being slightly elongated and flat, to at least functionally replicate the nipple of the mother rabbit or squirrel.

An input bore 30 is adapted for an interference fit with the cylinder extension 12A of the feeding syringe 10 of FIG. 1. The input bore 30 communicates with an outlet bore 32.

The nipple cap 24 is again of a solid elastomeric nature, configured as shown in the drawings, and characterized by bores 30, 32 communicating to nipple opening 33. The end of the nipple cap 24 has a flat face 34 for receipt by a corresponding flat face of the feeding syringe 10.

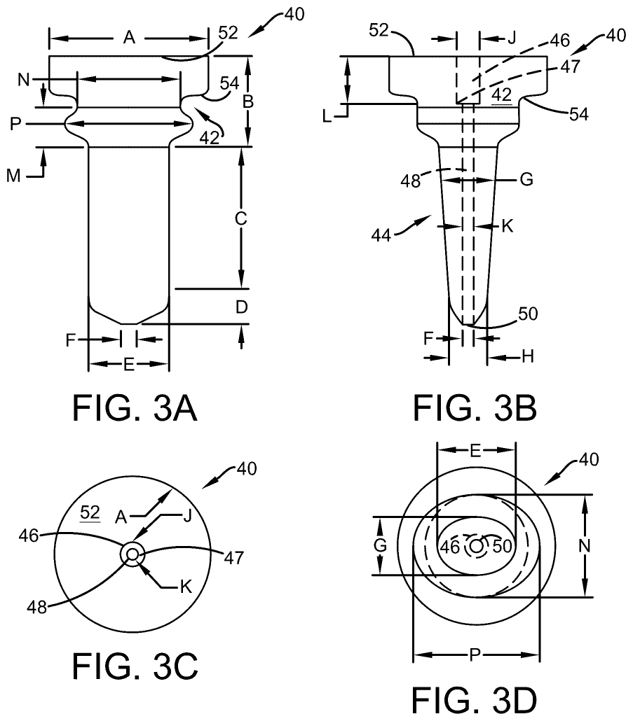

Referring now to FIGS. 3A-3D, it can be seen that a nursing nipple cap for white-tail deer fawns is designated generally by the numeral 40. Here again, the nipple cap 40 has a generally cylindrical body 42 that is stepped in nature and which extends to the nipple 44, again in a tapered elliptical cross-section to be rather more flat than circular in cross-section. The nipple 44 has an inlet bore 46, again adapted for a friction or interference fit with the cylinder extension 12A of the feeding syringe 10. The inlet bore 46 passes to an outlet bore 48 to the nipple opening 50.

By their nature, fawns are larger than baby rabbits, squirrels and the like. Their requirements for nursing and their ability to nurse significant quantities grows rapidly. Accordingly, it is contemplated that the nipple cap 40 for fawns may not require the slip or friction fit throughout the nursing period of the fawn. Rather, as the fawn grows and its capacity for nursing at a faster rate increases, the need for the slip or friction fit abates. Accordingly, it is contemplated that nipple cap 40 may actually be secured to a feeding syringe 10 by a threaded cap or the like. The cap would be annular in nature, with the opening therein being adapted for receipt by the shoulders 54. With the cap engaged with mating threads on the syringe body, the nipple 40 will be held in place during aggressive nursing. The need for a safety or relief valve is typically unnecessary at this age of the fawn —when it is capable of nursing without assistance.

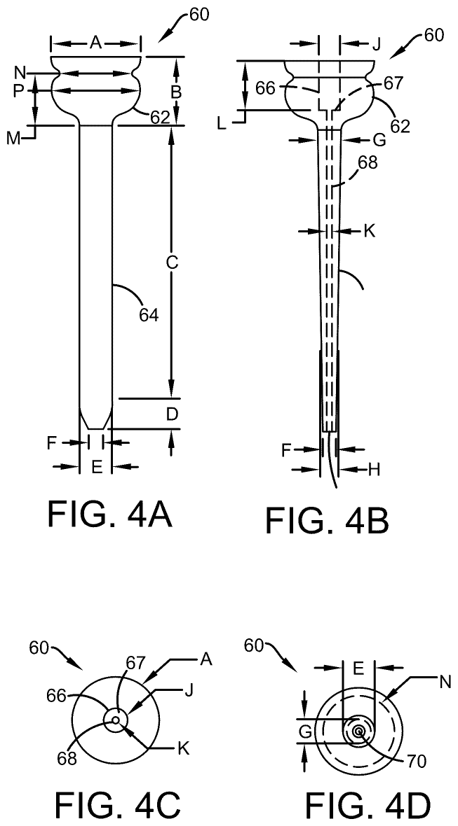

With reference now to FIG. 4, appreciation can be had of the structure and appearance of a nipple cap for use with opossum babies. Here, a stepped cylindrical body 62 has a nipple 64, again of substantially elliptical cross-section extending therefrom. An inlet bore 66 is received by the stepped cylindrical body 62 and is adapted for receipt by the cylinder extension 12A of the feeding syringe 10. The inlet bore 66 extends to an outlet bore 68 ending at the nozzle opening 70. Baby opossums are extremely small, and their nature is to substantially swallow the significant elongated nipple 64 and to retain the swallowed nipple while they are carried in the mother's pouch. Again, the intent is to functionally replicate the mother's teat in order to have the best possibility for survival of the orphaned baby.

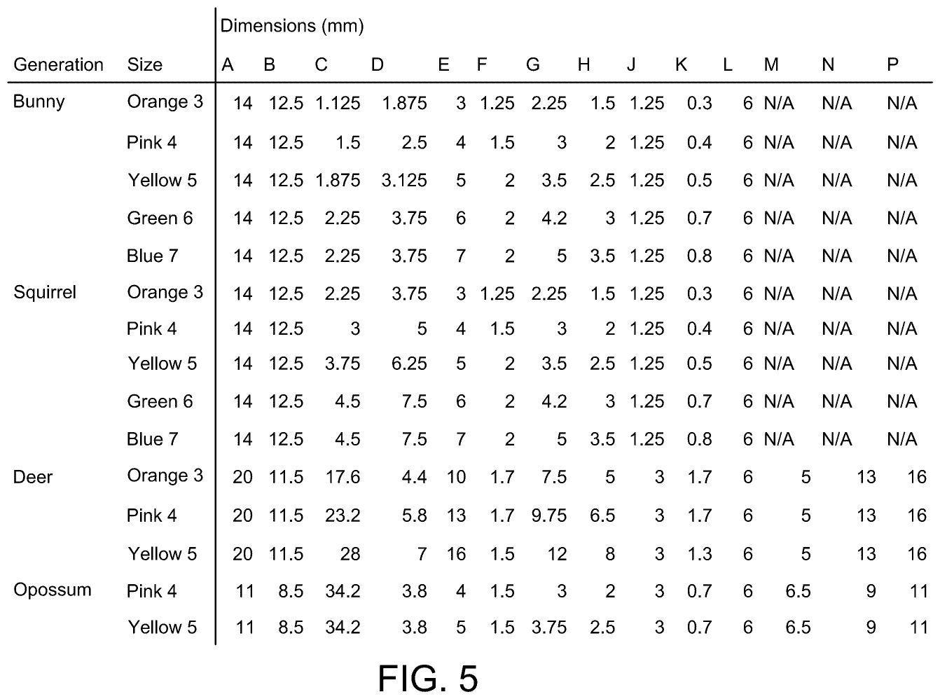

During the nursing stage, baby mammals grow significantly and, accordingly, the nature of the nursing nipple must change to accommodate the growth. Accordingly, the invention contemplates the employment of sets of nipples for each of the various baby animals to be employed during their nursing period. The sets for the animals treated above are presented in the chart of FIG. 5. As shown, bunnies and squirrel babies have been found to require on the order of five uniquely sized nipples during the nursing period, while deer require three and opossums two. The invention color codes the nipples, correlating the colors with the age range of the orphaned baby. The chart shows the species of the baby, the color of the associated nipple, and a number associated with that color that identifies the nursing period. The various structures designated by letters in the drawings of FIGS. 2A-2D, 3A-3D, and 4A-4D are presented on the chart with the associated dimensions set forth in millimeters. The chart contemplates a tolerance range on the order of 10%. The dimensional changes accommodate the growth of the baby to the point of being weened from nursing to more substantial nourishment sources.

As was mentioned above, the slip or friction fit between the cylinder extension 12A of the feeding syringe 10 and the inlet or input bore of the nipple establishes a relief valve or safety valve to prevent excessive milk, formula or the like from being forced at too high of a pressure or rate from the nipple opening. In this regard, it will be noted that the transition from the inlet bore to the outlet bore has a circumferential land thereabout. This land is designated by the numeral 31 in FIGS. 2B and 2C, by the numeral 47 in FIGS. 3B and 3C and by the numeral 67 in FIGS. 4B and 4C. The pressure of the fluid being urged through the syringe 10 impinges upon these lands and the force resulting therefrom urges the release of the associated nipple cap from the friction fit with the associated cylinder extension 12A. That interference is established by the relative dimension and the elastomeric material of the nipple cap to be sufficient to blow the cap off of the syringe if the pressure would be sufficient to cause a fluid flow resulting in aspiration of the baby animal. Such aspiration can otherwise result in death of the baby.

In a preferred embodiment of the invention, the nipple caps are manufactured of a soft silicone that is food safe and odorless, and contains no BPA, latex, lead or phthalates. In a preferred embodiment, the soft silicone material is vented to prevent nipple collapse and to promote a more comfortable feeding experience for the baby animals. The nipple cap is also preferably textured, similar to the mother's nipple, such that the baby can latch onto the nipple without slipping off. The nipple caps are also soft and stretchy, again replicating nature.

In addition to being tapered and elliptical, or somewhat flat, like the mother's nipples, the material is highly resistant to damage and degradation from extreme temperatures and will not harden, crack, peel, crumble, dry out, rot or become brittle over time. They are also resistant to heat, fungus and chemicals.

The pop-off pressure valve regulates pressure build-up in the flow chamber of the outlet bore to prevent aspiration.

The multiple sizes, as shown in FIG. 5, allow the feeding syringe 10 with nipple cap 22 to be adaptable to the baby animal as it grows in size and nursing needs.

Thus, it can be seen that the various aspects of the invention have been satisfied by the structure and associated method presented above. While in accordance with the patent statutes, only the best known and preferred embodiments of the invention have been presented and described in detail, the invention is not limited thereto or thereby. Accordingly, for an appreciation for the true scope of the invention, reference should be made to the following claims.

1. A nursing device for baby animals, comprising:
a feeding syringe; and
a nipple cap adapted for receipt by said syringe, said nipple cap having an elongated nipple of elliptical cross section on a plane perpendicular to an axis of said elongated nipple, said elongated nipple having an inlet bore in communication with said feeding syringe and an outlet bore interposed between and in communication with said inlet bore and a nipple opening.

2. The nursing device for baby animals as recited in claim 1, wherein said inlet bore has a larger diameter than said outlet bore.

3. The nursing device for baby animals as recited in claim 2, wherein a land is formed by an intersection of said inlet and outlet bores, said land defining a pressure relief valve for allowing said nipple cap to separate from said feeding syringe to prevent aspiration of a feeding baby animal.

4. (canceled)

5. The nursing device for baby animals as recited in claim 2, wherein said nipple cap has an enlarged body integral with said nipple, said body and nipple formed of an elastomer that is food safe and odorless, and contains no BPA, latex, lead or phthalates.

6. The nursing device for baby animals as recited in claim 5, wherein an outer surface of said nipple cap is textured, ensuring secure gripping engagement by a baby's mouth.

7. The nursing device for baby animals as recited in claim 6, wherein said nipple cap is selected from a plurality of nipple caps adapted for receipt by said feeding syringe, said plurality of nipple caps being sized, shaped and configured for use with baby animals of various specific species, ages and sizes.

8. The nursing device for baby animals as recited in claim 7, wherein said plurality of nipple caps are color coded to distinguish between the various ages and sizes of the baby animals as they mature.

9. The nursing device for baby animals as recited in claim 5, wherein said elastomer is a silicone elastomer.

10. A nursing device for baby animals, comprising:
a feeding syringe; and
a nipple cap adapted for receipt by said syringe, said nipple cap having an elongated nipple of elliptical cross section on a plane perpendicular to an axis of said elongated nipple, said elongated nipple having an inlet bore in communication with said feeding syringe and an outlet bore interposed between and in communication with said inlet bore and a nipple opening, said nipple cap having an enlarged body integral with said nipple, said body and nipple formed of a silicone elastomer.

11. The nursing device for baby animals as recited in claim 10, wherein said inlet bore has a larger diameter than said outlet bore establishing a land at an intersection of said inlet and outlet bores and wherein said land defines a pressure relief valve for allowing said nipple cap to separate from said feeding syringe from a force developed by a pressure upon said land.

12. (canceled)

13. (canceled)

14. The nursing device for baby animals as recited in claim 10, wherein an outer surface of said nipple cap is textured, ensuring secure gripping engagement by a baby's mouth.

15. The nursing device for baby animals as recited in claim 14, wherein said nipple cap is selected from a plurality of nipple caps adapted for receipt by said feeding syringe, said plurality of nipple caps being sized for use with baby animals of various specific species, ages and sizes.

16. The nursing device for baby animals as recited in claim 15, wherein said nipple caps are color coded to distinguish between the various ages and sizes of the baby animals as they mature.

17. A nursing device for baby mammals, comprising:
a cylinder defining a cavity having a fluid therein; and
a nipple cap adapted for receipt by said cylinder, said nipple cap having an elongated nipple of elliptical cross section on a plane perpendicular to an axis of said elongated nipple, said elongated nipple having an inlet bore in communication with said cavity and an outlet bore interposed between and in communication with said inlet bore and a nipple opening.

18. The nursing device for baby mammals as recited in claim 17, wherein an outer surface of said nipple cap is textured, ensuring secure gripping engagement by a baby's mouth.

19. The nursing device for baby animals as recited in claim 18, wherein said nipple cap is selected from a plurality of nipple caps adapted for receipt by said cylinder, said nipple caps being sized for use with baby mammals of various ages and sizes.

20. The nursing device for baby animals as recited in claim 19, wherein said nipple caps are color coded to distinguish between the various ages and sizes of the baby mammals as they mature.
